(19) United States
(12) Patent Application Publication
(10) Pub. No.: US 2016/0073665 A1
(43) Pub. Date: Mar. 17, 2016

(54) Gluten-Reduced and Gluten-Free Novel Food Products

(71) Applicant: Anish Mohindru, Laguna Woods, CA (US)

(72) Inventor: Anish Mohindru, Laguna Woods, CA (US)

(21) Appl. No.: 14/582,190

(22) Filed: Dec. 24, 2014

Related U.S. Application Data
(60) Provisional application No. 62/050,763, filed on Sep. 16, 2014.

(51) Int. Cl. A23L 1/29

(52) U.S. Cl. CPC A23L 1/293; A23V 2002/00

(57) ABSTRACT

The present invention teaches methods, processes, and engineered devices for the production of novel gluten-reduced or gluten-free health food products. The invented food products can be used as breads, pastas, dinner rolls, pies, cakes, tortillas, and pastries. The novel food product meets the need for a readily available, easily prepared, non-baked, low-glycemic-index, and nutrition-rich food products. The invented product exists as a non-wheat-based, easily obtainable, and healthy food, with a plurality of applications, shapes, compositions, presentations, uses, and methods of manufacture.

### CROSS-REFERENCE TO RELATED APPLICATION

This application claims the benefit of the filing date of U.S. Provisional Application No. 62/050,763 filed on Sep. 16, 2014 and entitled “Gluten-Reduced Novel Food Products,” which is hereby incorporated by reference thereto.

### FIELD OF INVENTION

The present invention teaches novel gluten-reduced and gluten-free health food products. The invented food products can be used as breads, tortillas, pies, pastas, cakes, and pastries. This invention meets the need for a readily available, easily prepared, non-baked, low-glycemic-index, and nutrition-rich food products. The invented product exists as a non-wheat-based, easily obtainable, and healthy food product, with a plurality of applications, shapes, compositions, presentations, uses, and/or methods of manufacture. The invention also covers methods of making the aforementioned food products, which are universally adoptable, and easily transferable for domestic use or commercial practice. The present invention further discloses engineered devices and instrumentation useful in the preparation of the herein described food products in the household and industry setting.

### BACKGROUND OF THE INVENTION

Grains and grain products are a staple in human diet virtually throughout the world. Flours from wheat and other grains, such as rye and barley, are used to bake breads, cakes, pies, tortillas, and to prepare various pastas. Wheat flour in particular provides a calorie-rich and nutritious combination of complex carbohydrates, proteins, minerals, and vitamins, with little or no fat.

The Centers for Disease Control (“CDC”) lists eight foods that can produce an allergic response in humans: milk, eggs, fish, crustacean shellfish, wheat, soy, peanuts, and tree nuts.⁽¹⁾ Food allergy from wheat can be traced to a protein called gluten, which is also found in rye and barley. Gluten is extremely harmful for a population who have a genetic disorder called celiac disease. According to the U.S. National Institutes of Health, “Celiac disease is an immune disease in which people can't eat gluten because it damages their small intestine. If you have celiac disease and eat foods with gluten, your immune system responds by damaging the small intestine. Celiac disease affects each person differently. Symptoms may occur in the digestive system, or in other parts of the body. One person might have diarrhea and abdominal pain, while another person may be irritable or depressed. Irritability is one of the most common symptoms in children. Some people have no symptoms. Celiac disease is genetic and no cure at this time. Based on the harmful potential of gluten, the USDA requires manufacturers to label processed food to disclose the presence of wheat.”⁽²⁾

In addition to the harmful effects suffered by celiac disease patients, gluten has been linked to health issues in the general public. In his book “Wheat Belly”⁽³⁾, William Davis, M.D., a practicing cardiologist, suggests that modern day wheat may be the cause for a rise in obesity and type-2 diabetes in the U.S. Fie provides evidence that, in addition to its high glycemic index, gluten in modern day wheat may have harmful effects in the human body, causing inflammation, creating an imbalance in electrolyte homeostasis, and possibly contributing to atherosclerosis. Besides gluten, wheat contains a class of amylopectins that are highly glycemic and cause insulin to spike in the blood. In conclusion, recent scientific discoveries suggest that humans could benefit from reducing or eliminating certain grain-based food from the diet.

### SUMMARY OF INVENTION

The present invention is directed to healthy food products made from non-wheat, non-grain materials with a plurality of applications, shapes, and compositions. The invented food products can be used to prepare breads, dinner rolls, pasta, tortillas, cakes, and pastries. The information disclosed herein describes these novel uses, methods of manufacture, and related instrumentation.

The non-wheat, non-grain materials used in the present invention refer to vegetables, fruits, and nuts, all of which humans have safely consumed for centuries. In contrast to the suspected negative health impact of high-caloric, gluten-containing, insulinogenic wheat products, “Eating vegetables provides health benefits—people who eat more vegetables and fruits as part of an overall healthy diet are likely to have a reduced risk of some chronic diseases. Vegetables provide nutrients vital for health and maintenance of your body”, as stated by United States Department of Agriculture (“USDA”).⁽⁴⁾

The methods, teaching, and ideas presented in this patent application are directed to the issues presented herein above, with the intent to decrease the use of the three gluten-containing grains—wheat, rye, and barley—from the human diet and to replace the same with vegetables, fruits, and nuts. Furthermore, this patent application teaches processes and methods that allow convenient domestic (home use), and industrial (manufacture and trade) use of vegetables, fruits, nuts, cooked grains (excluding wheat, rye, and barley), and beans to generate food products that an be conveniently produced and/or commercialized. The invented food product is versatile and can be used in a plurality of ways.

Specifically, this invention teaches a gluten-free healthy food product comprising of gluten-free, non-grain edible plant materials, and without the step of fermentation through yeast, baking powder, or other fermentation substances or organisms.

Furthermore, this invention teaches a gluten-free flour made from dehydration of gluten-free, non-grain edible plant materials.

Additionally, this invention teaches gluten-free healthy food products that are made from gluten-free flour, obtained from dehydrating non-grain edible plant materials, and by yeast fermentation and oven baking.

The invention further encompasses the devices and processes of making said healthy food products.

### BRIEF DESCRIPTION OF THE DRAWING

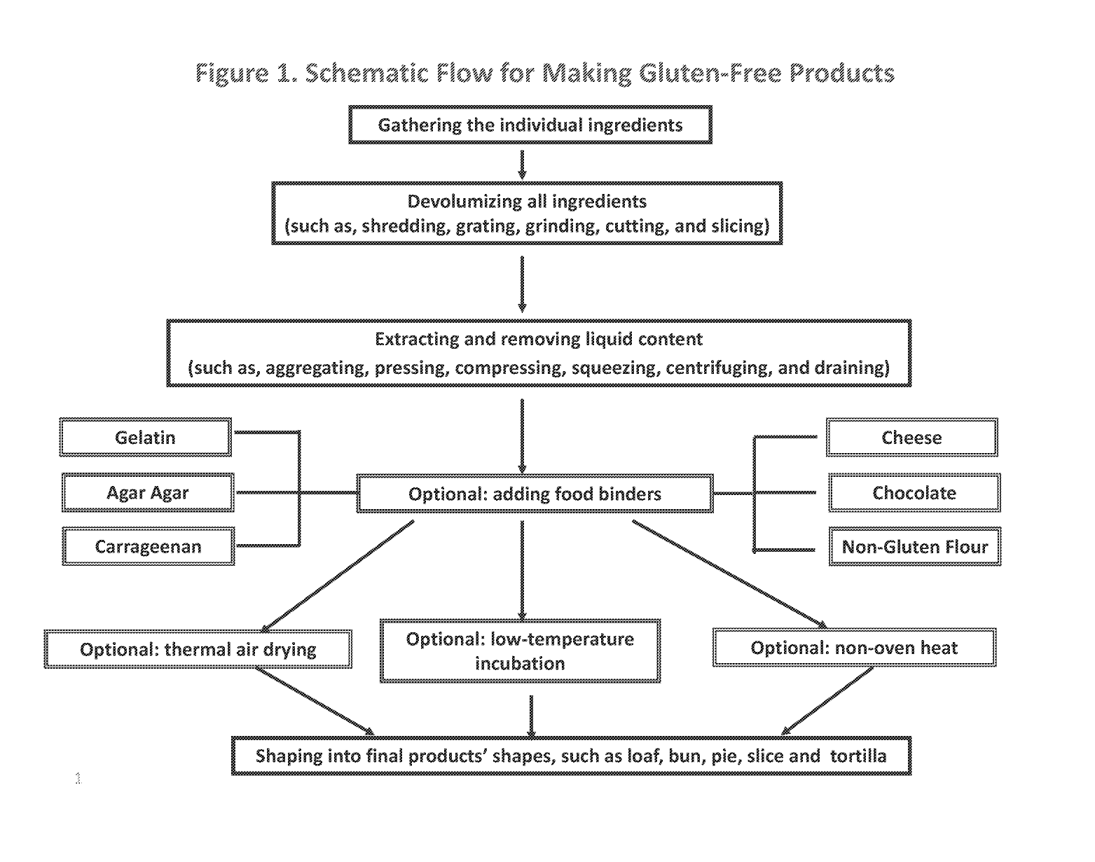

The invention is further explained with reference to the schema in the drawing (FIG. 1). This FIGURE illustrates a schematic flow process diagram of the multiple embodiments and steps for making gluten-free and gluten-reduced food products disclosed in this invention.

### DETAILED DESCRIPTION

Breads, dinner rolls, pies, cakes, tortillas, pastas, and other baked wheat products have been essential food items for thousands of years. Recent evidence links health problems and allergies to gluten-containing and hyperglycemic grains, namely wheat, rye, and barley. Accordingly, there is a pressing need to make gluten-reduced or gluten-free, reduced glycemic, healthy foods, which are nutritious, savory, and can be rendered into convenient food product shapes and sizes.

The present invention relates to gluten-free healthy food products, its composition, method of making and the devices used to make and manufacture the same.

Particularly, this invention relates to food products based on gluten-free edible plants, including, but not limited to, vegetables, fruits, herbs, edible flowers, mushrooms, and nuts. The vegetables further include leafy and salad vegetables, flowers and flower buds, podded vegetables, bulb and stem vegetables, root and tuberous vegetables, and sea vegetables. The invented food product may also contain food binders, condiments, seasonings, spices, and other flavoring additives, including sugar, salt, and pepper, which are routinely used in the kitchen. The described food products can be used as breads, pastas, tortillas, pies, cakes, cereals, rolls, crackers, food wrappers, food containers, and food films.

The present invention also relates to the method of making the gluten-free healthy food products. The invented food products can be made without fermentation or baking. The invented food products are made with the intent to preserve the natural biological structures of the raw food material and nutrients therein. The invented food products are made by physical aggregation of gluten-free edible plants to achieve desired and aforementioned results.

The present invention further relates to devices and/or instrumentations used to make and manufacture the healthy food products both in the household and industry settings. The engineered devices can effectively devolumize, downsize, aggregate, and adjoin edible plant materials.

In one embodiment, the food products can be made by reducing the size and volume of the raw plant ingredients, such as through slicing, grinding, and pressing, or using other methods that devolumize and introduce cohesion in the constituent matter.

The methods of aggregation comprise variously, but not exclusively, to the use of mechanical and other methods of compression and applying pressure to the desired plant material. In related practice, liquid nitrogen, refrigeration, and sub-freezing technology, thermal procedures, as well as other commonly used techniques illustrated herein may result in the inventive composition, use, process, or method of manufacture.

In one embodiment, the plant material used to make the food products may be placed in cheesecloth, which can be squeezed using a tourniquet motion, resulting in aggregate material that can be further processed to achieve a plurality of shapes and sizes.

In one embodiment, the plant materials may be desiccated, powdered, combined with other ingredients, and cooked to taste and texture specifications. The inventive art is the use of plant substance as a replacement of gluten-containing grains to produce food products.

In one embodiment, plant materials may be combined with condiments, herbs, spices, dressings, and other flavoring additives to introduce savoriness, to enhance the eating experience, and to add texture, color, or other palette-appealing properties.

In one embodiment, the plant materials may be heated to enhance flavor, taste, appearance, and texture.

In one embodiment, the main materials used in the food products are only vegetables, such as leafy vegetables, root vegetables, sea vegetables, and fruit vegetables.

In one embodiment, the main materials used in the food products are vegetables and natural-occurring food binders, such as starch, gelatin, carrageenan, xanthan gum, cheese, agar agar, and eggs.

In one embodiment, the food products made are vegetable tortillas mainly comprising of leafy vegetables and root vegetables.

In one embodiment, the food products made are vegetable tortillas mainly comprising of leafy vegetables, root vegetables, stem vegetables, and gelatin as the food binder.

In one embodiment, the food products made are vegetable tortillas mainly comprising of leafy vegetables, root vegetables, stem vegetables, and cheese as the food binder.

In one embodiment, the food products made are vegetable loaves mainly comprising of leafy vegetables, root vegetables, and fruit vegetables, without the need of fermentation or baking.

In one embodiment, the plant product can be co-mixed with non-hyperglycemic ingredients that are similar to amylopectin, but do not raise blood glucose levels to levels measured with wheat products.

In one embodiment, the plant product can be co-mixed with gluten-free flour.

In one embodiment, the plant product can be co-mixed with non-gluten protein, such as protein purified from rice.

The invention will be explained below with reference to a number of non-limiting examples. One or more of the steps within the examples can be combined or excluded.

### EXAMPLES

### Example 1

### Gluten-Free Food Product in the Shape of Bread Slice Made of Vegetables and Food Binders

a. The following ingredients were used:
   i. Baby carrots 3 oz.
   ii. Cauliflower 3 oz.
   iii. Iceberg lettuce 4 oz.
   iv. Plain reconstituted gelatin 3 tablespoons
b. The vegetables were devolumized by cutting into small pieces and the lettuce leaves were torn into smaller shreds.
c. Above were combined in a plastic bowl and 1 oz. of grated Mexican cheese (Kraft) was added.
d. The combined vegetables and cheese were added to a. plastic mold (a plastic food storage container purchased from a department store). The mold is 4.5×4.5×3 inches.
e. The container with the food product was placed in a microwave oven and heated for 30 seconds at high setting.
f. The mixture was tamped down using a second identical bowl with hand pressure and the escaping liquid was drained.
g. A total of 3 mL of the gelatin (reconstituted according to package instructions) was poured on the on top of the food matter.
h. The lid was closed and the container was placed in a kitchen refrigerator for 24 hours.
i. The resulting food product was removed from the container following the 24 hours incubation.
j. The resulting food product resembled a slice of bread, with regard to its rectangular shape, and was portable and held its shape upon handling.

### Example 2

### Gluten-Free Food Product in the Shape of Bread Slice Made of Vegetables with Bread Crumb Coatings

a. Example 1 was repeated with the following changes
   i. The vegetables were devolumized into shreds by using a hand grater
   ii. One Tsp of gluten free breadcrumbs (Ener-G) were sprinkled on top of the compressed vegetable matter after the addition of the gelatin.

This experiment yielded a product similar to Example 1.

### Example 3

### Gluten-Free Food Product in the Shape of Loaf Made of Vegetables

A commercially available press was used to produce a vegetable-based loaf that can be sliced and used to make a “sandwich”, The press was used to induce fluid loss from the vegetable matter.
a. Instrument used to press ingredients: “Single Paper Log Briquette Maker”, manufactured by Northern Industrial Tools (Burnsville, Minn.) and sold online by Kotula's (www.kotulas.com).
b. The following food ingredients were used
   i. Baby carrots 6 oz.
   ii. Cauliflower 3 oz.
   iii. Celery 6 oz.
   iv. Bell pepper 6 oz.
   v. Broccoli 6 oz.
   vi. Red bell pepper 6 oz.
   vii. Red radish 6 oz.
   viii. Mexican Shredded Cheese (Kraft) 3 oz.
   ix. Iceberg lettuce 12 oz.
c. The vegetables were devolumized into shreds in a food processor (Kitchenaid Chef's Chopper)
d. The lettuce was hand torn to small pieces, about 1 inch square.
e. The plant mass was placed in a large plastic bowl. The cheese was added to the plant matter and contents were hand mixed to achieve a homogeneous mixture.
f. The contents were poured into the log maker.
g. The press was operated (as instructed by the manufacturer) by pressing down on the two arms which create torque on the material in contact with the press member. Fluid escaped from the plant mass from holes present in the press chamber. The mass of the remaining plant matter was greatly reduced.
h. Gelatin was dissolved according to package instructions (sprinkle powder from four packages into 4 oz. of cold water). The powder was allowed to dissolve undisturbed and microwaved at high power for 30 seconds. The liquid gelatin was cooled to room temperature and then slowly poured over the top of the plant loaf.
i. The levered press assembly was dismantled, leaving the plant loaf in the chamber.
j. The press was placed in a refrigerator for 24 hours (incubation period).
k. Upon completion of the incubation period, the removable member in the press slowly lifted. It was necessary to slide a knife down the sides to dislodge the adhesed food product.
l. The resulting plant loaf was then removed from the tray and placed on a cutting board. It was measured (8.5×3×3 inches) and weighed (43.5 oz.).
m. The mechanical pressing action resulted in a 29% fluid loss.
n. The plant loaf could be sliced. The slices could be picked up and handled with ease. The slices were used to make a “sandwich”. Mayonnaise was applied to the surface of the plant slice. Cheese and sliced turkey were placed on the mayonnaise, and a second slice was overlaid. The resulting food product could be picked up, handled, and easily consumed.
This example clearly demonstrated that the principles of this invention can be practiced to yield a novel gluten-free product.

### Example 4

### Gluten-Free Food Product in the Shape of Loaf Made of Vegetables using Alternate Ingredients

a. The process of Example 3 was repeated with the following differences:
b. Ingredients included shredded carrots (12 oz.), bell pepper (8 oz.), cauliflower (10 oz.), celery (20 oz.), drained contents of a 15.5 oz. can of garbanzo beans (shredded), and 10 oz. of cooked brown basmati rice.
c. The resulting food product was similar in shape to that obtained in the previous example.

### Example 5

### Gluten-Free Food Product in the Shape of Loaf Made of Vegetables

a. Ingredients Used
   i. 2 lb. celery
   ii. 1 lb. carrots
   iii. 1 lb. cauliflower
   iv. 1 cup shredded cilantro
   v. ½ teaspoon salt and black pepper
Shred using electric food chopper.
b. Compress as shown in Example 3, weight after compression is 2 lb. 9 oz.
c. Use the above processed food matter to make bread loaf through below steps.
Take 12 oz. of above material,
Add 4 oz. mozzarella cheese (Kraft, low moisture),
Mix and place at high heat in microwave for 30 seconds,
Press into 5.5-inch loaf pan,
Dissolve 4 packs of gelatin according to package instructions,
Add to the food matter in pan,
Refrigerate for 8 hours,
d. Results in a loaf that can be sliced and compatible for making a sandwich,

### Example 6

### Gluten-Free Food Product in the Shape of Bun Made of Vegetables

a. Ingredients Needed
   i. ½ cup of the processed food matter as in Example 5, Step b
   ii. ⅓ cup flax seed meal (bulk purchase, Sprouts)
   iii. ⅓ cup mozzarella grated, dry packaged cheese (Kraft)
   iv. 1 teaspoon ranch dressing powder admixed with 2 Tsp water
b. Mix above ingredients.
c. Microwave for 30 seconds.
d. Shape the food matter into a ball-like shape with flat bottom and top, similar to a bun.
e. Refrigerate for eight hours.
f. Cut in half horizontally and use to make a sandwich, apply condiments and place meat, cheese, tomatoes.

### Example 7

### Gluten-Free Tortilla Made of Vegetables

a. A ⅓ cup portion of the processed food matter was obtained as in Example 5, Step b.
b. Garbanzo flour (2 tablespoons) was added to the above.
c. Gelatin was reconstituted and added to above.
d. The food matter was mixed and shaped by hand into a tortilla.
e. The prepared tortilla could be used to make a taco with meat and other accompaniments.

### Example 8

### Gluten-Free Pie Made from Fruits

a. Two small Fuji apples were shredded using hand kitchen grater.
b. The food matter from above was compressed to remove moisture as above.
c. Four tablespoons liquid agar-agar were prepared according to package instructions.
d. Binder was added to the shredded, compressed apple.
e. The food matter was pressed into a 4.25 springform pan (Mainstays Mini 4.75×1.75 inches) to create a crust.
f. The pan was refrigerated for 8 hours.
g. The crust was removed from the pan by opening spring latch.
h. Whipped cream obtained from grocery store was added to obtain a fruit-crusted, cream pie.

Example 9

### Gluten-Free Pie Made from Fruits and Chocolate

a. Six small Fuji apples were shredded (shred size approximately ¾ inches) using a hand-operated kitchen grater (weight after shredding 8 oz.),
b. The press was used as above to remove excess water (final weight 4 oz.).
c. Four oz. Nestle Milk Chocolate Chips (for baking) were placed in a bowl.
d. The chocolate chips were melted in the microwave.
e. The melted chocolate was added to the shredded apples.
f. Two tablespoons of granulated cane sugar were added.
g. All ingredients were mixed by hand.
h. The material was packed into a springform baking pan and press to reduce volume.
i. The preparation was incubated in a refrigerator for 8 hours.
j. The pie was removed from the pan and sliced for consumption.

### Example 10

### Gluten-Free Pie Made from Air-Dried Vegetables and Flax Meal

a. A total 78 oz. of roughly cut vegetables (zucchini, cauliflower, celery, carrots, and jalapeños) were dried in a Nesco Dehydrator (American Harvest) according to manufacturer instructions for 10 hours. The dry weight of the vegetables was 11 oz.
b. The vegetables were shredded in a food processor (Ninja).
c. The food matter was further ground further to small particle size in a coffee grinder (Mr. Coffee). The final food product particles measure approximately 2 mm and adhere easily on pressing by hand.
d. A 3 oz. amount of the grounded material was placed in a bowl.
e. Flax meal (2 oz., bulk purchase from super market) was mixed with the vegetable matter along with 1 oz. water. The material was kneaded to a dough-like consistency.
f. Unflavored gelatin (Knox Original Gelatin Unflavored, Four Envelopes, Net Weight 1 oz.) was dissolved and added to the dough, and the product was pressed into a springform pie pan overnight incubation in the refrigerator.
g. The finished product was removed from the pan by releasing the spring lock.
h. The prepared food product was released on to a cutting board where it was sliced vertically into two halves. One of the halves was then slice horizontally to demonstrate that that the food product was firm and can be consumed as a pie slice.
The invention is described in conjunction with the foregoing specific examples. It will be recognized that many alternatives, variations, and modifications will be apparent to those of ordinary skill in the art. Those alternative, variations and modifications are intended to fall within the spirit and scope of the present invention.

### APPENDIX

### CITED REFERENCES

1. www.cdc.gov/healthyyouth/foodallergies/
   Retrieved on Aug. 8, 2014.
2. http://www.nlm.nih.gov/medlineplus/celiacdisease.html
   Retrieved on Aug. 8, 2014.
3. Wheat Belly. William Davis, MD. Rodale, N.Y., 2011
4. www.choosemyplate.gov<MyPlate<Vegetables
   Retrieved on Aug. 8, 2014.

I claim:

1. A gluten-free healthy food product comprising of
i. one or more edible gluten-free non-grain plant materials;
ii. one or more gluten-free food binders comprising of gelatin, cheese, starch, cellulose, carrageenan, agar agar, chocolate, egg, and alginate; and
iii. not containing yeast, baking powder, or other fermentation substances or organisms.

2. The gluten-free healthy food product of claim 1 further comprising gluten-free seasonings, spices, dressings, and other flavor-enhancing ingredients.

3. The one or more edible gluten-free non-grain plant materials of claim 1 are selected from one or more of the following:
i. root vegetables comprising of carrot, beet, radish, beetroot, swede, parsnip, celeriac, and rutabaga;
ii. leafy vegetables comprising of iceberg lettuce, green lettuce, red lettuce, kale, mustard, collard, turnip greens, Swiss chard, and spinach;
iii. stem vegetables comprising of bamboo, bamboo shoot, asparagus, arctium, celery, cardoon, fallopian, rheum, and smilax;
iv. flower vegetables comprising of cauliflower, broccoli, artichoke, cabbage, Brussels sprout, and caper;
v. fruit vegetables comprising of tomato, cucumber, squash, zucchinis, pepper, eggplant, avocado, bean, bell pepper, capsicum, courgette, okra, pumpkin, choko, scaloppini, and peas;
vi. fruits comprising of apple, apricot, banana, cherry, melon, plum, grape, pear, orange, lime, lemon, kiwi, mango, pomegranate, berry, papaya, jujube, fig, and pineapple;
vii. seeds and seed meals, comprising of flaxseed, sunflower, pumpkin, and melon;
viii. beans and peas, comprising of kidney beans, pinto beans, garbanzo beans, black beans, lima beans, black-eyed peas, split peas, and lentils;
ix. culinary and medicinal herbs, comprising of cilantro, Chinese parsley, parsley, thyme, lavender, basil, mint, rosemary, bay laurel, and dill; and
x. gluten-free cereals, comprising, of rice, buckwheat, oats, quinoa, maize, and sorghum.

4. The gluten-free healthy food product as claim 1 is a tortilla wherein the one or more edible gluten-free non-grain plant materials are selected from the group of
i. root vegetables comprising of carrot, beet, and rutabaga;
ii. leafy vegetables comprising of iceberg lettuce, green lettuce, red lettuce, kale, mustard, collard, turnip greens, Swiss chard, and spinach;
iii. stem vegetables comprising of bamboo, bamboo shoot, asparagus, arctium, celery, cardoon, and smilax;
iv. fruit vegetables comprising of cucumber, tomato, and bell pepper;
v. beans and peas, comprising of kidney beans, pinto beans, garbanzo beans, black beans, lima beans, black-eyed peas, split peas, and lentils; and
vi. culinary and medicinal herbs, comprising of cilantro, Chinese parsley, parsley, thyme, lavender, basil, mint, rosemary, bay laurel, and dill.

5. The gluten-free healthy food product as claim 1 is a bread in the shape of a bun, a slice or a loaf, wherein the one or more edible gluten-free non-grain plant materials are selected from
i. root vegetables comprising of carrot, beet, and rutabaga;
ii. leafy vegetables comprising of iceberg lettuce, green lettuce, red lettuce, kale, mustard, collard, turnip greens, Swiss chard, and spinach;
iii. stem vegetables comprising of bamboo, bamboo shoot, asparagus, arctium, celery, cardoon, and smilax;
iv. flower vegetables comprising of cauliflower, broccoli, artichoke, cabbage, Brussels sprout, and caper;
v. fruit vegetables comprising of cucumber, tomato and bell pepper; and
vi. beans and peas, comprising of kidney beans, pinto beans, garbanzo beans, black beans, lima beans, black-eyed peas, split peas, and lentils.

6. The gluten-free healthy food product as in claim 1 is in the shape of a pie wherein
i. the one or more edible gluten-free non-grain plant materials are selected from the fruits comprising of apple, apricot, banana, cherry, melon, plum, grape, pear, orange, lime, lemon, kiwi, mango, pomegranate, berry, papaya, jujube, fig, and pineapple;
ii. the one or more gluten-free food binders comprising of gelatin, starch, cellulose, carrageenan, agar agar, and chocolate; and
iii. optionally flax seed meal.

7. A gluten-free healthy food product made by the steps comprising of
i. gathering and mixing the edible gluten-free non-grain plant materials;
ii. devolumizing the plant materials by one or more steps of chopping, cutting, grating, grinding, and shredding;
iii. extracting and removing the liquids from the edible gluten-free non-grain plant materials by one or more steps comprising of aggregating, pressing, compressing, squeezing, centrifuging, and draining;
iv. shaping the processed edible gluten-free non-grain plant materials into desired shapes; and
v. without the step of fermentation through yeast, baking powder, or other fermentation substances or organisms.

8. The gluten-free healthy food product in claim 7 wherein Step (ii) is done in a food processer.

9. The food processer of claim 8 comprising of a food grinder, a food blender, a food liquidizer, a food grater, and a food mixer.

10. The gluten-free healthy food product in claim 7 wherein Step (iii) is done in a processer.

11. The processer of claim 10 comprising of a puri maker, a plastic mold, a briquette maker, a tofu maker, and a centrifuging machine.

12. The gluten-free healthy food product in claim 7 further comprising the step of adding gluten-free food binders.

13. The gluten-free healthy food product in claim 7 further comprising the step of temperature treatment of the plant materials which is comprised of non-oven heating, refrigerator incubation, and liquid nitrogen cryo-treatment.

14. The gluten-free healthy food product of claim 7 is comprising of bread, dinner rolls, loaf, bun, tortilla, pasta, dinner roll, pie, and cake.

15. A process of making a gluten-free healthy food product comprising the steps of
i. devolumizing the edible gluten-free non-grain plant materials by one or more steps of chopping, cutting, grating, grinding and shredding; and
ii. extracting and removing the liquids from the edible gluten-free non-grain plant materials by one or more steps comprising of aggregating, pressing, compressing, squeezing, centrifuging, and draining.

16. The process of claim 15 further comprising the process of binding the edible gluten-free non-grain plant materials with gluten-free binders comprising of gelatin, cheese, starch, cellulose, carrageenan, agar agar, chocolate, and alginate.

15. process of claim 15 further comprising the process of temperature treatment of the edible gluten-free non-grain plant materials comprising of non-oven heating, refrigerator incubation, and liquid nitrogen cryo-treatment.

18. The process of claim 15 further comprising the process of air drying the edible gluten-free non-grain plant materials using non-industrial dehydrators.

19. The process of claim 15 comprising the use of a food processor comprising of a food grinder, a food blender, a food liquidizer, a food mixer, a food presser, a food grater, and a food dehydrator.

20. The food processor of claim 19 wherein the food processor can implement shredding, compressing, and extracting and removing the liquids from the edible gluten-free non-grain plant materials in one single step.
